(19) United States
(12) Patent Application Publication
(10) Pub. No.: US 2026/0189747 A1
(43) Pub. Date: Jul. 2, 2026

(54) SYSTEM FOR REPOSITIONING DATA IN A VIDEO STREAM AND A METHOD THEREOF

(71) Applicant: Samsung Electronics Co., Ltd., Suwon-si (KR)

(72) Inventors: Saurabh PAREEK, Noida (IN); Tarun GUPTA, Noida (IN); Ankesh KASLIWAL, Noida (IN); Jayant Kumar NAGAL, Noida (IN)

(21) Appl. No.: 19/551,901

(22) Filed: Feb. 27, 2026

Related U.S. Application Data
(63) Continuation of application No. PCT/KR2024/016059, filed on Oct. 22, 2024.

(30) Foreign Application Priority Data
Nov. 8, 2023 (IN) 202311077233

(51) Int. Cl. H04N 21/431; H04N 21/41; H04N 21/462

(52) U.S. Cl. CPC H04N 21/4316; H04N 21/4122; H04N 21/462

(57) ABSTRACT

A method and system to reposition data associated with a video stream. The method includes identifying data from a plurality of frames of the video stream being played on a user equipment. The method comprises identifying a plurality of regions and separates first data and second data from the identified data. The method comprises determining a viewability index of the first data based on a plurality of parameters of the video stream and repositions the first data in the at least one of the plurality of regions based on the determined viewability index. The repositioned first data is visible on a user interface associated with a target device.

### CROSS-REFERENCE TO RELATED APPLICATION

This application is a by-pass continuation application of International Application No. PCT/KR2024/016059, filed on Oct. 22, 2024, which is based on and claims priority to Indian Patent Application number 202311077233, filed on Nov. 8, 2023 in the Indian Patent Office, the disclosures of which are incorporated by reference herein in their entireties.

### BACKGROUND

### Field

The disclosure relates to a field of video streams, and more particularly relates to a system and a method of repositioning data, wherein the data includes at least one of a lost data or a data with reduced visibility associated with the video stream.

### Description of Related Art

Conventionally, users would prefer to watch videos on electronic devices like televisions. Further, with the advancement of technologies, the users have multiple options, for example, a smartphone, a smart television, a laptop, etc., to watch videos. From the multiple options, the users prefer to watch the videos on their smartphones as the smartphones are easy to carry and provides a comfortable viewing experience to the user. However, viewing the videos on the smartphones has limitations, as shown in FIG. 1, that when a user watches the video in a normal screen mode in the smart hone 102, in that case, the user experiences blurred resolution of the video which also hampers a readability of data, that is, textual information 104 provided in the video. Further, in another case, when the user watches the video in a full screen mode, in that case, the user experiences a good resolution of the video, however, with loss of the data 104 provided in the video.

Additionally, the user may face loss of the data from the video while watching the video in different scenarios. As shown in FIG. 2, in one scenario, during multitasking 202, that is, when the user is streaming the video on a television and working on the smartphone, in that case, the user will not be able to see the data on the smartphone. In another scenario, when the user watches the video in a background on the smartphone (picture-in-picture mode) 204 while performing some other work on the smartphone, etc. In yet another scenario, when the user watches the video on a smart watch 206 and lastly, when the user watches the video in the low resolution 208. In all these above scenarios the user faces loss of data while watching the video.

Thus, there is a trade-off between the good resolution of the video and the textual information provided in the video due to different aspect ratios, bad resolution, content size, and divided focus of the user.

In this regard, many technological solutions have been developed to overcome the abovementioned problem. For instance, in a known art, a light filter is added for underexposed regions. In particular, edges are determined, and a smoothed version of the image is generated. Also, a greyscale version of the image is generated and both images are compared and underexposed regions are given additional exposure. However, the known art focuses on providing the illumination to the underexposed area. Thus, the technical problem as discussed earlier remains in the known art.

Hence, it is advantageous and desirable to provide a system and a method that may maintain the data such that the data is readable to the user while eliminating or mitigating at least one of the abovementioned technical problems.

### SUMMARY

In an embodiment, the disclosure discloses a system configured to reposition data associated with a video stream. The system includes memory and at least one processor. The at least one processor is communicably coupled with the memory. The at least one processor is configured to identify data from a plurality of frames of the video stream being played on a user equipment (UE). The data includes at least one of a lost data or a data with a reduced visibility. The at least one processor is configured to identify, from the plurality of frames of the video stream, a plurality of regions. The at least one processor is configured to separate a relevant data and an irrelevant data from the identified data in at least one of the plurality of regions. The at least one processor is configured to determine a viewability index of the relevant data based on a plurality of parameters of the video stream. The at least one processor is configured to reposition the relevant data in the at least one of the plurality of regions based on the determined viewability index. The repositioned relevant data is visible on a user interface associated with a target device.

In an embodiment, also disclosed herein is a method of repositioning data associated with a video stream. The method includes identifying data from a plurality of frames of the video stream being played on a user equipment (UE). The data includes at least one of a lost data or a data with a reduced visibility. The method includes identifying, from the plurality of frames of the video stream, a plurality of regions. The method further includes separating a relevant data and an irrelevant data from the identified data in at least one of the plurality of regions. The method furthermore includes determining a viewability index of the relevant data based on a plurality of parameters of the video stream. The method includes repositioning the relevant data in the at least one of the plurality of regions based on the determined viewability index. The repositioned relevant data is visible on a user interface associated with a target device.

In an embodiment, the disclosure is provided a method for repositioning data associated with a video stream, the method comprising: identifying the data from contents associated with a plurality of frames of the video stream being displayed on a user equipment (UE), wherein the data includes at least one of a lost data or a data with reduced visibility; identifying, from the plurality of frames of the video stream, a plurality of regions based on the identified contents; separating a relevant data and an irrelevant data from the identified data provided in at least one of the plurality of regions; determining a viewability index of the relevant data based on a plurality of parameters associated with the video stream; and repositioning the relevant data in the at least one of the plurality of regions based on the determined viewability index, wherein the repositioned relevant data is visible on a user interface associated with a target device.

The method may comprise, prior to the identification of the data from the contents associated with the plurality of frames: identifying at least one mode from a plurality of modes of the video stream, wherein the plurality of modes includes one of a display mode and a hidden mode. The method may comprise: determining a viewability index of at least one frame from the plurality of frames based on the plurality of parameters, wherein the plurality of parameters includes at least one of a resolution, a content size, a brightness, a distance, and an orientation; and determining status of the data visibility in the contents of the video stream based on a status of a plurality of factors associated with the video stream and the at least interest of a user, wherein the plurality of factors includes at least one of a pause state of the video stream, interaction of the user with the UE, interaction of the user with a linked device of the UE, interaction of the user with the target device, and lost contents from the video stream; and wherein the status of the data visibility includes the at least one of the lost data or the data with the reduced visibility.

In some embodiments the identification of the data from the contents associated with the plurality of frames, the method may comprise: converting at least one frame from the plurality of frames into a plurality of grid blocks; and determining a viewability index of each block of the at least one frame based on the plurality of parameters, to identify the data including the at least one of the lost data or the data with the reduced visibility, wherein the plurality of parameters includes at least one of resolution, content size, brightness, distance, and orientation. Prior to the identification, from the plurality of frames of the video stream, of the plurality of regions, the method for determining the plurality of regions may comprise: determining a first plurality of regions from the plurality of frames, at an initial state of the video stream; determining a second plurality of regions from the plurality of frames of the video stream after a specified time interval; comparing the first plurality of regions and the second plurality of regions to determine the plurality of regions, wherein the plurality of regions includes a static region and a dynamic region; and determining a viewability index of the determined plurality of regions.

After the separation of the relevant data and the irrelevant data from the identified data, provided in the at least one of the plurality of regions, the method may comprise: determining the at least one of the plurality of regions having the identified data, wherein the at least one of the plurality of regions is a static region; determining a viewability index of a plurality of blocks of the at least one of the plurality of regions; comparing the determined viewability index with a threshold viewability index; and extracting, based on the comparison, the relevant data from the identified data in the at least one of the plurality of regions. For the repositioning the relevant data in the at least one of the plurality of regions, the method may comprise: determining size of the at least one of the plurality of regions, where the at least one of the plurality of regions is a static region; determining contrast ratio of the at least one of the plurality of regions and the relevant data, when the size of the at least one of the plurality of regions is optimum for the relevant data; determining a viewability index of the at least one of the plurality of regions and the relevant data; and repositioning the relevant data in the at least one of the plurality of regions wherein the repositioned relevant data is visible on the user interface associated with the target device. When the size of the at least one of the plurality of regions is not optimum for the relevant data, the method may comprise: forming an overlay; identifying a shape of the overlay; dividing the relevant data into a plurality of parts to be placed within the identified shape of the overlay; and repositioning the relevant data in the at least one of the plurality of regions, wherein the repositioned relevant data is visible on the user interface associated with the target device. For the formation of the overlay, the method may comprise: extracting a colour matrix of the at least one of the plurality of regions, where the at least one of the plurality of regions is the static region; selecting a colour spectrum with contrasting colour; determining a colour coefficient of each colour provided in the colour spectrum; determining a contrast coefficient of each of the colour with the colour matrix of the static region to select an optimum colour; determining a viewability index to generate an optimum shape having the optimum colour; applying the optimum colour and the optimum shape to the overlay, when the viewability index is optimum; and placing the overlay on the user interface of the target device, wherein the overlay is configured to place the plurality of parts of the relevant data on the user interface of the target device. Before placing the overlay on the user interface of the target device, the method may comprise: selecting background of the overlay, wherein the background is selected based on a combination of a static region, a background colour corresponding to the relevant data in the static region, and a foreground colour corresponding to the relevant data in the static region; and selecting font of the plurality of parts of the relevant data. The relevant data may be repositioned on the user interface of the target device in response to receiving a user input indicative of switching from the video stream.

In an embodiment, the disclosure is provided a system to reposition data associated with a video stream, the system comprising: memory; and at least one processor communicably coupled with the memory, the at least one processor is configured to: identify the data, from contents associated with a plurality of frames of the video stream being displayed on a user equipment (UE), wherein the data includes at least one of a lost data or a data with a reduced visibility; identify, from the plurality of frames of the video stream, a plurality of regions, based on the identified contents; separate a relevant data and an irrelevant data from the identified data provided in at least one of the plurality of regions; determine a viewability index of the relevant data based on a plurality of parameters associated with the video stream; and reposition the relevant data in the at least one of the plurality of regions based on the determined viewability index, wherein the repositioned relevant data is visible on a user interface associated with a target device.

The target device may be one of the UE or different from the UE, herein the target device (306) is wirelessly connected with the UE. The target device may be at least one of smart watch, a television, a desktop, a laptop, a smartphone. Prior to the identification of the data from the contents associated with the plurality of frames, the at least one processor may be configured to: identify at least one mode from a plurality of modes of the video stream, wherein the plurality of modes includes one of a display mode and a hidden mode.

The at least one processor may be configured to: determine a viewability index of at least one frame from the plurality of frames based on the plurality of parameters, wherein the plurality of parameters includes at least one of a resolution, a content size, a brightness, a distance, and an orientation; and determine status of the data visibility in the contents of the video stream based on a status of a plurality of factors associated with the video stream and the at least interest of a user, wherein the plurality of factors includes at least one of a pause state of the video stream, interaction of the user with the UE, interaction of the user with a linked device of the UE, interaction of the user with the target device, and lost contents from the video stream; and wherein the status of the data visibility includes the at least one of the lost data or the data with the reduced visibility.

For the identification of the data from the contents associated with the plurality of frames, the at least one processor may be configured to: convert at least one frame from the plurality of frames into a plurality of grid blocks; and determine a viewability index of each block of the at least one frame based on the plurality of parameters, to identify the data including the at least one of the lost data or the data with the reduced visibility, wherein the plurality of parameters includes at least one of resolution, content size, brightness, distance, and orientation. Prior to the identification, from the plurality of frames of the video stream, of the plurality of regions, for determining the plurality of regions the at least one processor may be configured to: determine a first plurality of regions from the plurality of frames, at an initial state of the video stream; determine a second plurality of regions from the plurality of frames of the video stream after a specified time interval; compare the first plurality of regions and the second plurality of regions to determine the plurality of regions, wherein the plurality of regions includes a static region and a dynamic region; and determine a viewability index of the determined plurality of regions. After the separation of the relevant data and the irrelevant data from the identified data, provided in the at least one of the plurality of regions, the at least one processor may be configured to: determine the at least one of the plurality of regions having the identified data, wherein the at least one of the plurality of regions is a static region; determine a viewability index of a plurality of blocks of the at least one of the plurality of regions; compare the determined viewability index with a threshold viewability index; and extract, based on the comparison, the relevant data from the identified data in the at least one of the plurality of regions.

For the reposition of the relevant data in the at least one of the plurality of regions, the at least one processor may be configured to: determine size of the at least one of the plurality of regions, where the at least one of the plurality of regions is a static region; determine a contrast ratio of the at least one of the plurality of regions and the relevant data, when the size of the at least one of the plurality of regions is optimum for the relevant data; determine a viewability index of the at least one of the plurality of regions and the relevant data; and reposition the relevant data in the at least one of the plurality of regions wherein the repositioned relevant data is visible on the user interface associated with the target device. When the size of the at least one of the plurality of regions is not optimum for the relevant data, the at least one processor may be configured to: form an overlay; identify a shape of the overlay; divide the relevant data into a plurality of parts to be placed within the identified shape of the overlay; and reposition the relevant data in the at least one of the plurality of regions, wherein the repositioned relevant data is visible on the user interface associated with the target device. For the formation of the overlay, the at least one processor may be configured to: extract a colour matrix of the at least one of the plurality of regions, where the at least one of the plurality of regions is the static region; select a colour spectrum with contrasting colour; determine a colour coefficient of each colour provided in the colour spectrum; determine a contrast coefficient of each of the colour with the colour matrix of the static region to select an optimum colour; determine a viewability index to generate an optimum shape having the optimum colour; apply the optimum colour and the optimum shape to the overlay, when the viewability index is optimum; and place the overlay on the user interface of the target device, wherein the overlay is configured to place the plurality of parts of the relevant data on the user interface of the target device. Before placing the overlay on the user interface of the target device, the at least one processor may be configured to: select background of the overlay, wherein the background is selected based on a combination of a static region, a background colour corresponding to the relevant data in the static region, and a foreground colour corresponding to the relevant data in the static region; and selecting font of the plurality of parts of the relevant data. The relevant data may be repositioned on the user interface of the target device in response to receiving a user input indicative of switching from the video stream.

In an embodiment, the disclosure is provided a method of repositioning data for display. The method may comprise computing a viewability index of a (full) frame of a video stream being played in order to determine whether the frame includes non-viewable data (e.g. lost data and/or data having reduced visibility). The method may comprise dividing the frame into a plurality of blocks. The method may comprise computing a viewability index for each of the plurality of blocks. The method may comprise identifying a plurality of regions in the frame, each of the plurality of regions comprising a set of connected blocks (e.g. vertically or horizontally adjacent blocks having similar colour/opacity values) from amongst the plurality of blocks. The method may comprise identifying at least one static region (e.g. a region where there is little or no movement/change over a sequence of frames of the video stream) from amongst the plurality of regions. The method may comprise identifying at least one data-containing region from amongst the plurality of regions that contains relevant/extractable data (e.g. textual or numerical information). The method may comprise computing an average viewability index of the data-containing region using the computed viewability index of each of the blocks of the data-containing region. If the average viewability index is below a threshold value the method may comprise extracting the relevant/extractable data from data-containing region. The method may comprise positioning the extracted relevant/extractable data in a said static region for display. The viewability index will typically represent user readability/viewability of content in the frame. The user readability/viewability of the content in the frame may be dependent on, for example, zooming, PIP mode, screen resolution/size, a user switching screens/devices, etc. The threshold value may be based on a viewability index computed for the frame. The method may further comprise initially detecting whether a user device is playing a video stream. A system configured to operate the method may also be provided.

In an embodiment, the disclosure is provided a computer-readable medium storing a computer program to operate any method described herein.

To further clarify the advantages and features of the disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates a scenario depicting at least one of a lost data or a data with reduced visibility in a device as per known art;

FIG. 2 illustrates multiple scenarios depicting the at least one of the lost data or the data with reduced visibility as per known art;

FIG. 3 illustrates a block diagram of an environment of a system communicably coupled with a user equipment (UE) and a target device, in accordance with an embodiment of the disclosure;

FIG. 4 illustrates a block diagram of the system in communication with the user equipment and the target device, in accordance with an embodiment of the disclosure;

FIG. 5A, FIG. 5B, FIG. 5C, and FIG. 5D illustrate a plurality of modes of video stream in the UE, in accordance with an embodiment of the disclosure;

FIG. 6 illustrates a formation of a grid on at least one frame, in accordance with an embodiment of the disclosure;

FIG. 7A and FIG. 7B illustrate processes for determining a plurality of regions, in accordance with an embodiment of disclosure;

FIG. 8 and FIG. 9 illustrate processes for repositioning the relevant data on the user interface of the target device, in accordance with an embodiment of the disclosure;

FIG. 10 illustrates a process for a formation of an overlay, in accordance with an embodiment of the disclosure;

FIG. 11 illustrates a process for a formation of background of the overlay, in accordance with an embodiment of the disclosure;

FIG. 12 illustrates a method performed by the system, in accordance with an embodiment of the disclosure; and

FIG. 13A, FIG. 13B, and FIG. 13C illustrate multiple use cases of the system for repositioning the at least one of the lost data or the data with reduced visibility, in accordance with an embodiment of the disclosure.

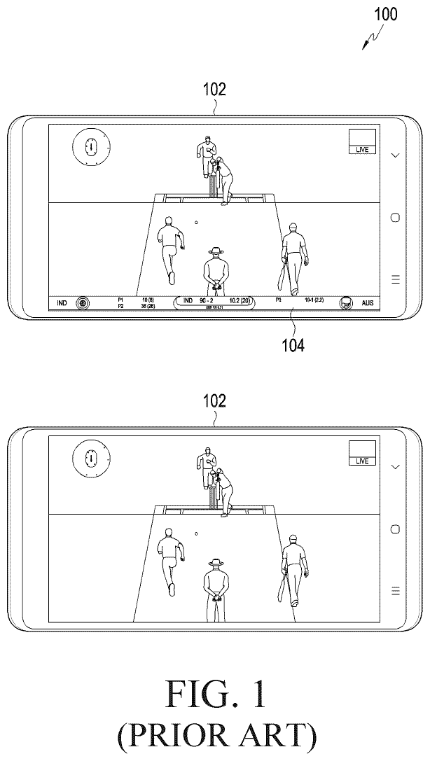

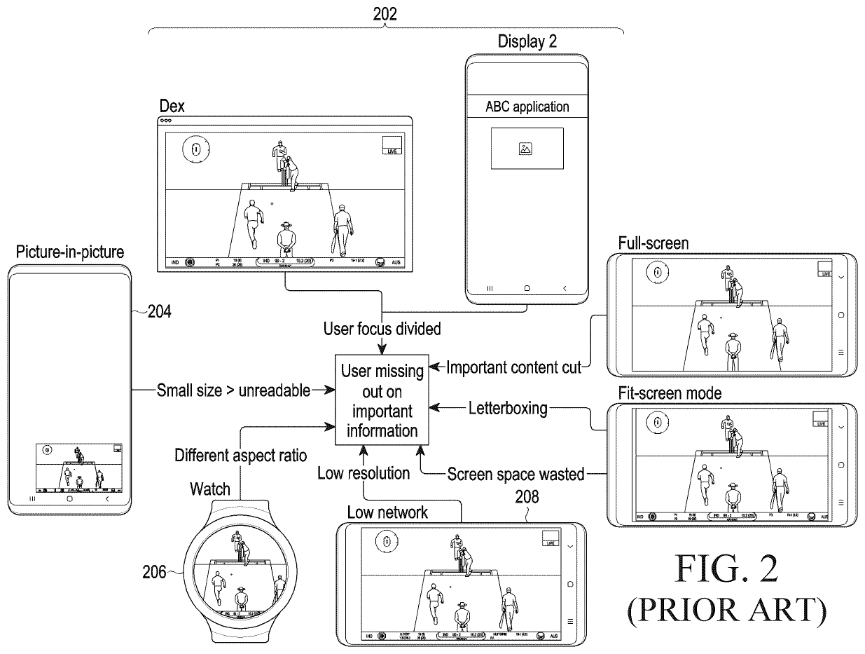

Further, skilled artisans will appreciate that elements in the drawings are illustrated for simplicity and may not have necessarily been drawn to scale. Furthermore, in terms of the construction of the device, a plurality of components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates. Unless otherwise defined, all technical and scientific terms used herein have the same meaning as commonly understood by one of ordinary skilled in the art to which disclosure belongs. The system and examples provided herein are illustrative only and not intended to be limiting.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the scope of the disclosure in any way.

For example, any terms used herein, such as “includes,” “comprises,” “has,” “consists,” and similar grammatical variants do not specify an exact limitation or restriction, and certainly do not exclude the possible addition of a plurality of features or elements, unless otherwise stated. Further, such terms must not be taken to exclude the possible removal of the plurality of the listed features and elements, unless otherwise stated, for example, by using the limiting language including, but not limited to, “must comprise” or “needs to include.”

Whether or not a certain feature or element was limited to being used only once, it may still be referred to as “plurality of features” or “plurality of elements” or “at least one feature” or “at least one element.” Furthermore, the use of the terms “plurality of” or “at least one” feature or element do not preclude there being none of that feature or element, unless otherwise specified by limiting language including, but not limited to, “there needs to be plurality of . . . ” or “plurality of elements is required.”

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the disclosure. Some embodiments have been described for the purpose of explaining plurality of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, plurality of particular features and/or elements described in connection with plurality of embodiments may be found in one embodiment, or may be found in more than one embodiment, or may be found in all embodiments, or may be found in no embodiments. Although plurality of features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

Embodiments of the disclosure will be described below in detail with reference to the accompanying drawings.

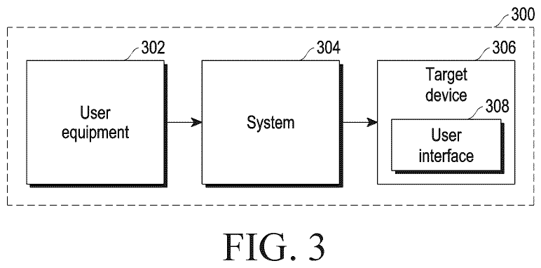

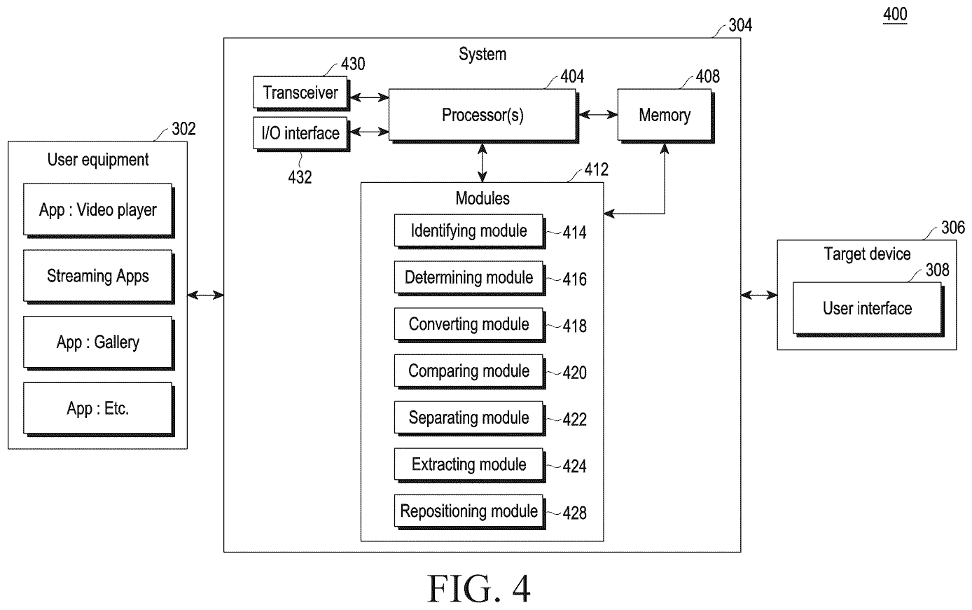

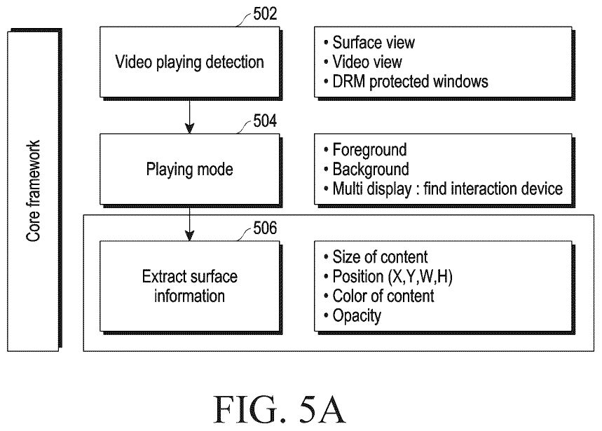

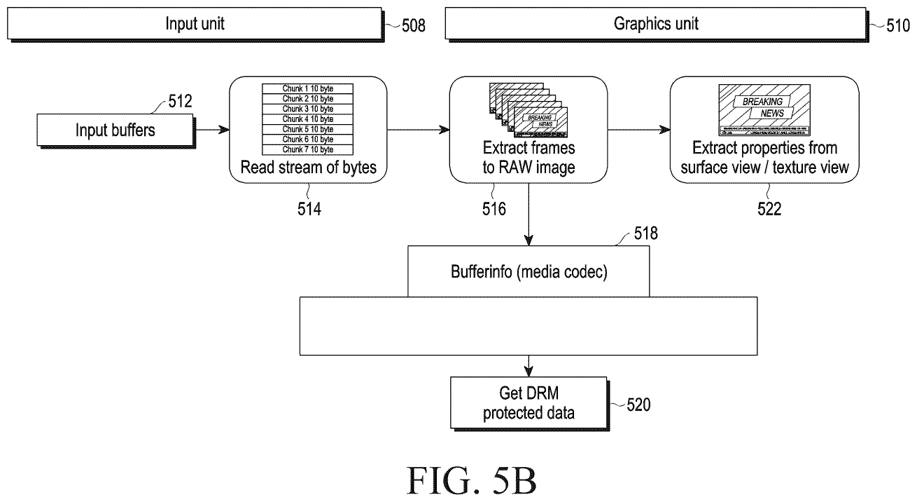

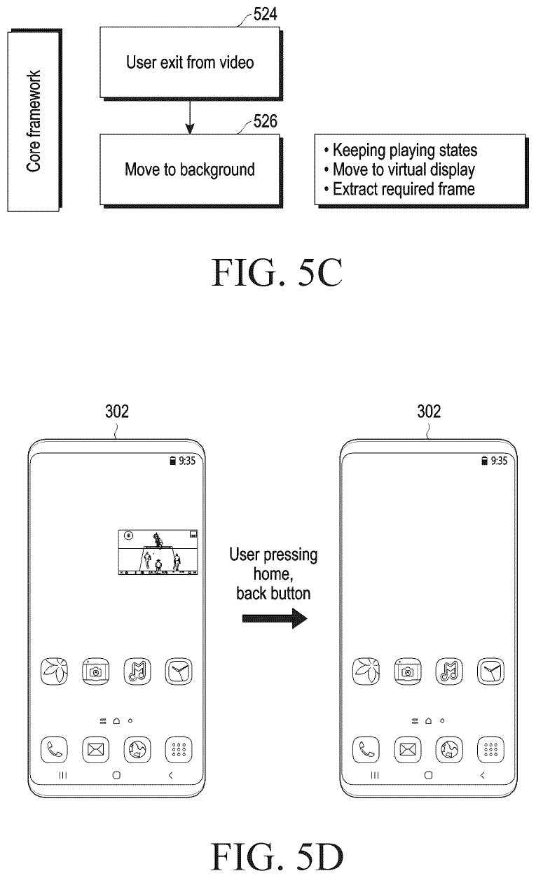

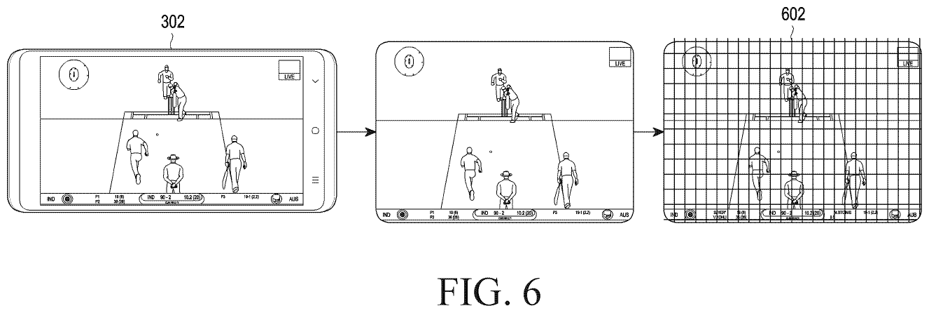

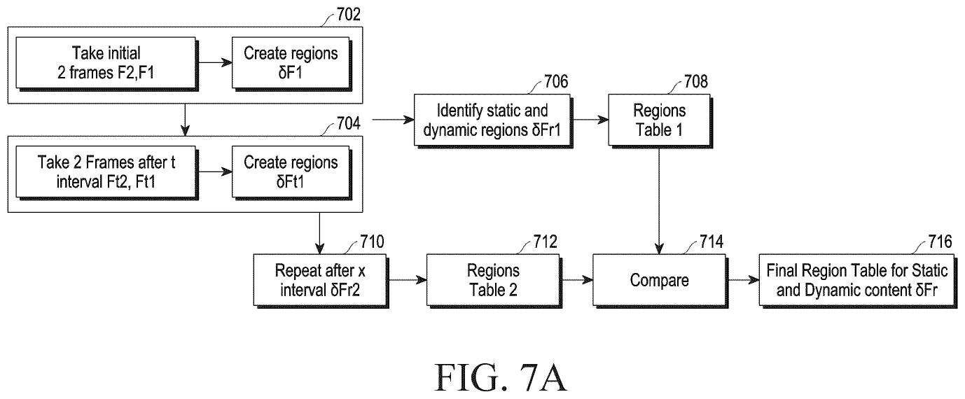

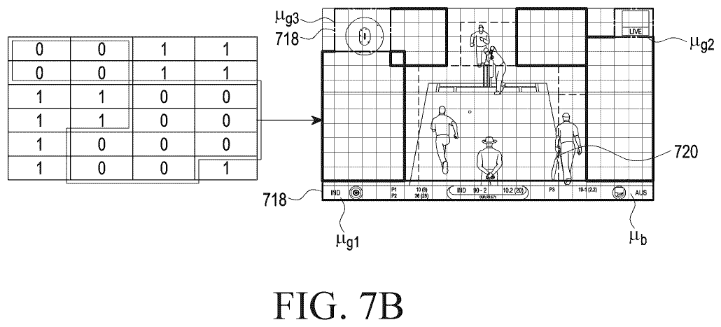

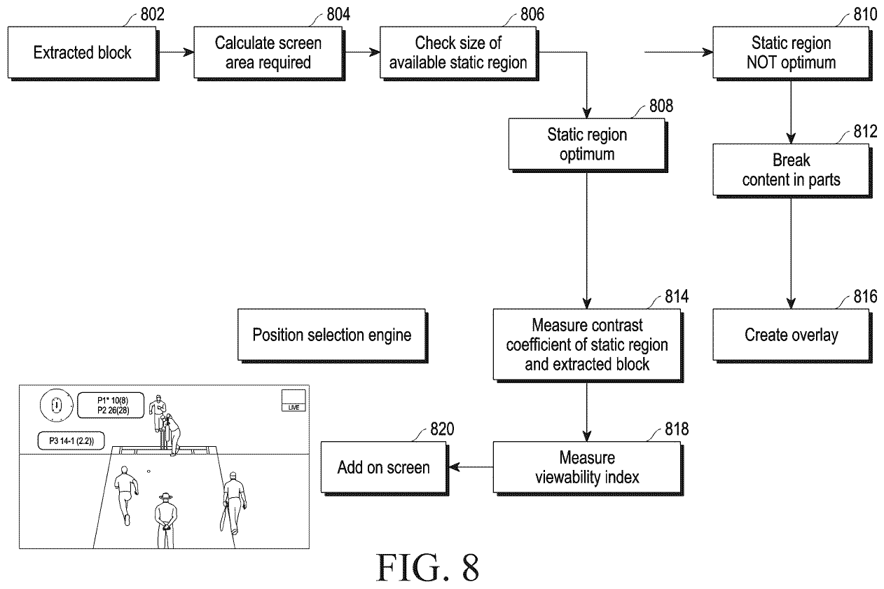

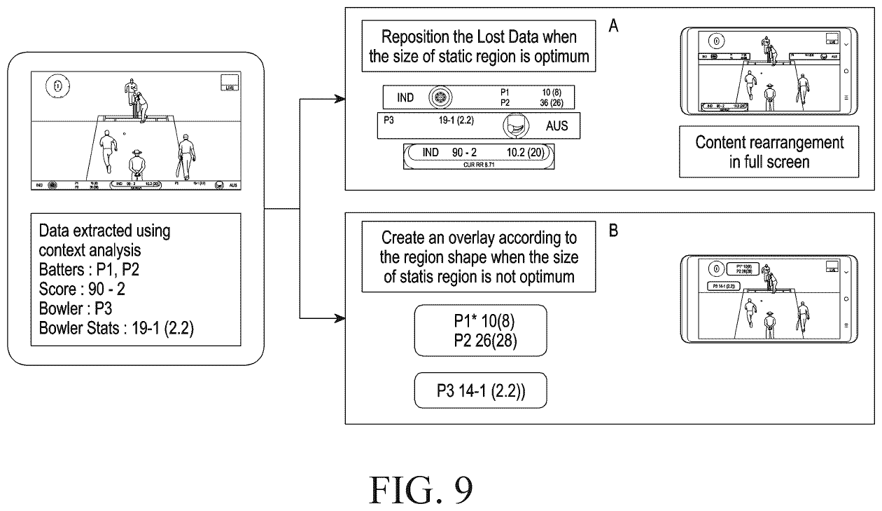

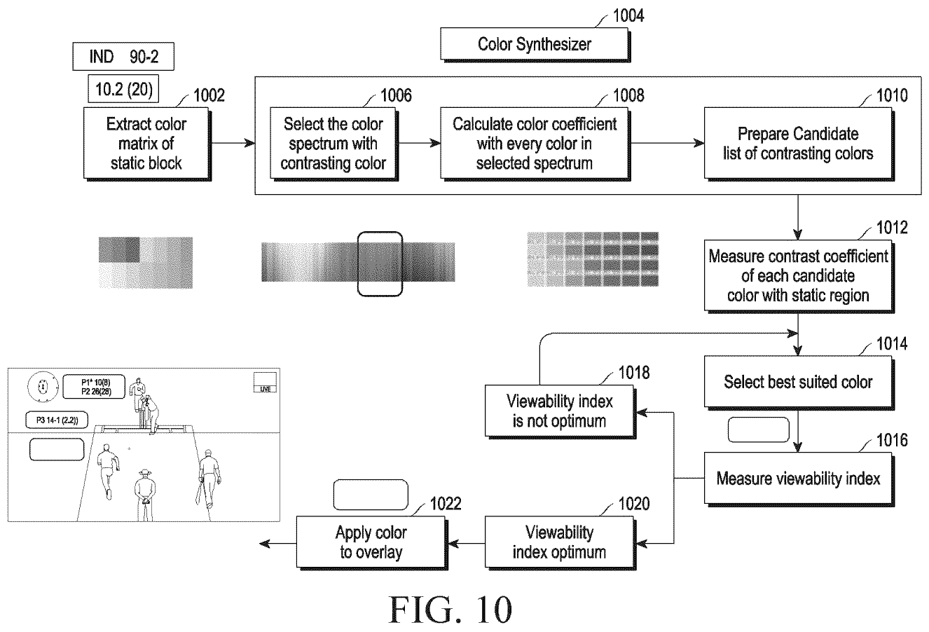

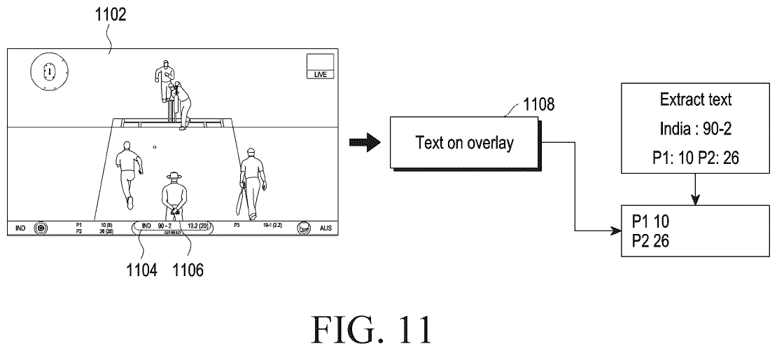

FIG. 3 illustrates an environment 300 of a system 304 communicably coupled with a user equipment 302 and a target device 306, in accordance with an embodiment of the disclosure. FIG. 4 illustrates a block diagram of the system 304 in connection with the user equipment 302 and the target device 306, in accordance with an embodiment of the disclosure. FIGS. 5a, 5b, 5c, and 5d illustrate a plurality of modes of video stream in the UE 302, in accordance with an embodiment of the disclosure. FIG. 6 illustrates a formation of a grid on at least one frame, in accordance with an embodiment of the disclosure. FIGS. 7a and 7b illustrate processes for determining a plurality of regions, in accordance with an embodiment of the disclosure. FIGS. 8 and 9 illustrate processes for repositioning the relevant data on the user interface 308 of the target device 306, in accordance with an embodiment of the disclosure. FIG. 10 illustrates a process for a formation of an overlay, in accordance with an embodiment of the disclosure. FIG. 11 illustrates a process for a formation of background of the overlay, in accordance with an embodiment of the disclosure.

In an embodiment, the user equipment 302 may include multiple applications, for example, video player applications, video stream applications, gallery etc. When the video is streamed in the user equipment (UE) 302, the system 304 may be configured to identify data, where the data includes at least one of a lost data or a data having reduced visibility, associated with the video stream. The lost data may comprise data in the video stream that is outside a screen area or viewport currently viewed by a user. The data having reduced visibility may comprise data, such as text, that is too small for a user to comfortably discern or read. The lost data or the data having reduced visibility may result from, for example, zooming, PIP mode, screen resolution/size, a user switching screens/devices, etc.

Further, the system 304 is configured to reposition the identified data, associated with the video stream, in a user interface 308 of the target device 306. In an embodiment, the target device 306 may be the same as the user equipment 302 without departing from the scope of the disclosure. In an embodiment, the target device 306 may be different from the user equipment 302, where the target device 306 may be wirelessly connected with the user equipment 302, without departing from the scope of the disclosure. In an embodiment, the target device 306 may be at least one of a smartphone, a television, a smart watch, a desktop, a laptop, etc., without departing from the scope of the disclosure.

In an embodiment, the system 304 may include, but is not limited to, at least one processor (referred here as one or more processor, a processor) 404, memory 408, and a plurality of modules 412 among other examples which are explained in detail in subsequent paragraph.

The system 304 may include an Input/Output (I/O) interface 432, a transceiver 430, a view system, a window manager, a user interface of the system 304, a multitasking, graphics layer having information about buffer and drawings of a graphics buffer. In an embodiment, the view system may include the creation of all surface views and overlay views, without departing from the scope of the disclosure. In an embodiment, the window manager may provide the size of a visible window, without departing from the scope of the disclosure.

Further, in some embodiments where the system 304 is implemented as a standalone entity at a server/cloud architecture, the system 304 may be in communication with multiple user equipment to receive data from each of the multiple user equipment, and the details provided below with respect to the system 304 and the user equipment 302 is applicable for the system 304 and the multiple user devices as well.

In an exemplary embodiment, the processor 404 may be operatively coupled to each of the I/O interface 432, the plurality of modules 412, the transceiver 430, and the memory 408. In one embodiment, the processor 404 may include a graphical processing unit (GPU) and/or an AI Engine (AIE). In one embodiment, the processor 404 may include at least one data processor for executing processes in a virtual storage area network. The processor 404 may include specialized processing units such as, integrated system (bus) controllers, memory management control units, floating point units, graphics processing units, digital signal processing units, etc. In one embodiment, the processor 404 may include a central processing unit (CPU), a graphics processing unit (GPU), or both. The processor 404 may be one or more general processors, digital signal processors, application-specific integrated circuits, field-programmable gate arrays, servers, networks, digital circuits, analog circuits, combinations thereof, or other now known or later developed devices for analyzing and processing data. The processor 404 may execute a software program, such as code generated manually (i.e., programmed) to perform the desired operation.

The processor 404 may be disposed in communication with one or more input/output (I/O) devices via the I/O interface 432. In some embodiments, the processor 404 may communicate with the UE 302, and the target device 306 using the I/O interface 432. In some embodiments, the I/O interface 432 may be implemented within the user equipment 302. The I/O interface 432 may employ communication code-division multiple access (CDMA), high-speed packet access (HSPA+), global system for mobile communications (GSM), long-term evolution (LTE), WiMax, or the like, etc. In an embodiment, the I/O interface 203 may enable input and output to and from the system 304 using suitable devices such as, but not limited to, display, keyboard, mouse, touch screen, microphone, speaker and so forth.

Using the I/O interface 432, the system 304 may communicate with one or more I/O devices, specifically, the user equipment 302, from which the system 304 identifies the lost data, and the target device 306. For example, the input device may be an antenna, microphone, touch screen, touchpad, storage device, transceiver, video device/source, etc. The output devices may be a video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The processor 404 may be disposed in communication with a communication network via a network interface. In an embodiment, the network interface may be the I/O interface 432. The network interface may connect to the communication network to enable connection of the system 304 with the UE 302 and/or the target device 306. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 304 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

The transceiver 430 may be configured to receive and/or transmit signals to and from the UE 302. In one embodiment, the database may be configured to store the information as required by the plurality of modules 412 and the processor 404 to perform one or more functions for repositioning the identified data on the UE 302/the target device 306.

In some embodiments, the memory 408 may be communicatively coupled to the processor 404. The memory 408 may be configured to store data, and instructions executable by the processor 404. In one embodiment, the memory 408 may be provided within the UE 302. In another embodiment, the memory 408 may be provided within the system 304 being remote from the UE 302. In yet another embodiment, the memory 408 may communicate with the processor 404 via a bus within the system 304. In yet another embodiment, the memory 408 may be located remote from the processor 404 and may be in communication with the processor 404 via a network. The memory 408 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In one example, the memory 408 may include a cache or random-access memory for the processor 404. In alternative examples, the memory 408 is separate from the processor 404, such as a cache memory of a processor, the system memory, or other memory. The memory 408 may be an external storage device or database for storing data. The memory 408 may be operable to store instructions executable by the processor 404. The functions, acts or tasks illustrated in the figures or described may be performed by the programmed processor 404 for executing the instructions stored in the memory 408. The functions, acts or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In some embodiments, the plurality of modules 412 may be included within the memory 408. The memory 408 may further include a database to store data. The plurality of modules 412 may include a set of instructions that may be executed to cause the system 304, in particular, the processor 404 of the system 304, to perform any one or more of the methods/processes disclosed herein. The plurality of modules 412 may be configured to perform the steps/operations of the disclosure using the data stored in the database. For instance, the plurality of modules 412 may be configured to perform the steps/operations disclosed in FIGS. 5a-10.

In an embodiment, each of the plurality of modules 412 may be a hardware unit which may be outside the memory 408. Further, the memory 408 may include an operating system for performing one or more tasks of the system 304, as performed by a generic operating system.

In one example, the modules 412 may include an identifying module 414, a determining module 416, a converting module 418, a comparing module 420, a separating module 422, an extracting module 424, and a repositioning module 428. Each of the identifying module 414, the determining module 416, the converting module 418, the comparing module 420, the separating module 422, the extracting module 424, and the repositioning module 428 may be in communication with each other. Further, each of the identifying module 414, the determining module 416, the converting module 418, the comparing module 420, the separating module 422, the extracting module 424, and the repositioning module 428 may be in communication with the processor 404.

Further, the disclosure contemplates a computer-readable medium that includes instructions or receives and executes instructions responsive to a propagated signal. Further, the instructions may be transmitted or received over the network via a communication port or interface or using a bus (not shown). The communication port or interface may be a part of the processor 404 or may be a separate component. The communication port may be created in software or may be a physical connection in hardware.

The communication port may be configured to connect with a network, external media, the display, or any other components in the system, or combinations thereof. The connection with the network may be a physical connection, such as a wired Ethernet connection or may be established wirelessly. Likewise, the additional connections with other components of the system 304 may be physical or may be established wirelessly. The network may alternatively be directly connected to a bus. For the sake of brevity, the architecture and standard operations of the memory 204, the processor 404, the transceiver 205, and the I/O interface 203 are not discussed in detail.

Further, in an embodiment, the working of the system 304 to reposition the identified data on the user interface 308 of the target device 306 is explained in detail in subsequent paragraphs in conjunction with FIG. 3 to FIG. 11.

The processor 404, in conjunction with the identifying module 414, the determining module 416, the converting module 418, the comparing module 420, the separating module 422, the extracting module 424, and the repositioning module 428 may be configured to perform specific operation explained in subsequent paragraphs.

In an embodiment, prior to the identification of the data, the identifying module 414 may be configured to identify at least one mode from a plurality of modes of the video stream. In an embodiment, the plurality of modes includes one of a display mode and a hidden mode, without departing from the scope of the disclosure.

In an embodiment, as referring to FIGS. 5A and 5B, in an embodiment, the video stream in the display mode may be identified by a plurality of techniques, for example, ViewTreeObserver.

In particular, when the video stream is detected at a operation 502, data imported from a source streaming the video, for example, a disk/network, may be provided as an input to an input buffer 512 of an input unit 508. Further, a continuous stream of bytes 514 is generated from the data provided at the input buffers and further, the continuous stream of bytes 514 is read/analysed. In an embodiment, once the stream of the bytes is analysed, a plurality of raw images/frames is decoded. In an embodiment, the plurality of raw images/frames may be provided as an input to a graphics unit 510. Further, at a operation 516, a plurality of frames is extracted from the plurality of raw images and is provided to a buffer information (media codec) 518. In an embodiment, the buffer information (media codec) 518 may include a media extractor, a media metadata retriever, and an adaptive manifest manager. The buffer information (media codec) 518 may generate the DRM protected data.

In an embodiment, referring to FIG. 5A, once the video stream is detected at the operation 502, subsequently at operation 504, the display mode of the video stream may be identified on at least a foreground of a user interface of the user equipment 302, a background of the user interface of the user equipment 302, an interaction of the user with a linked device of the user equipment (UE) 302 (multi display), without departing from the scope of the disclosure.

Further, once the display mode is identified and the plurality of frames is extracted from the plurality of raw images, at a operation 506 and at a operation 522, surface information is extracted from the plurality of raw images/frames. In an embodiment, the plurality of raw images/frames may be presented on a surface view/flinger and further data/information, for example, size of a playing content, position of the playing content, colour of the content, capacity, status of the video stream, foreground, background, display ID of the UE 302, the DRM protected content, is extracted from the surface view/flinger. This configuration assists in identifying the video streaming in the display mode.

In the hidden mode, referring to FIG. 5C, at a operation 524, when the user exits from the videos stream by pressing at least one of a home button and a back button in the UE 302, in that case, the video stream is moved to the background of UE 302 as shown in a operation 526. In particular, referring to FIG. 5D, when the user presses the one of the home button and the back button on the UE 302, in that case, onPause for the video stream is identified. This, configuration helps in determining that the video stream is happening in the hidden mode.

In an embodiment, once the at least one of the plurality of modes of the video stream is determined, the determining module 416 may be configured to determine a viewability index (μ_{full}) of at least one frame from a plurality of frames of the video stream based on a plurality of parameters. The viewability index of the at least one frame is a numerical representation of the likelihood that the at least one frame will be seen by the UE 302. In an embodiment, the plurality of parameters includes at least one of a resolution, a content size, a brightness, a distance, and an orientation, without departing from the scope of the disclosure. In another embodiment, the plurality of parameters may also include a size of the user interface of the UE 302, a size of the content of the video streaming on the UE 302, a grid size, a type of the video streaming on the UE 302, a type of the content of the video streaming on the UE 302, distance of a user from the UE 302, orientation of the user with respect to the UE 302, to identify that the lost data is continuous part of the video streaming or any different overlay in the video streaming, to identify portions of the display unit of the UE 302 which may be blocked due to system messages, for example, notification/toasts/other disturbances, to identify the video streaming being closed or gone to a background of the UE 302, to identify number of displays/devices connected and if any video streaming occurring on those devices In an embodiment, the viewability index of the at least one frame may be determined by:

$$μ full = \frac{{\sum }_{i = 1}^{3} {σ}_{i} \times {∈}_{i}}{σ \times {∈}_{max}} \\ {∈}_{3} = \frac{Brightness}{Device Brightness} \qquad Formula 1$$

In an embodiment, an optimum determined viewability index of the at least one frame may be less than 0.20, without departing from the scope of the disclosure. In an embodiment σ may represent a standard deviation of a population.

Further, after determining the viewability index, the determining module 416 may be configured to determine a data visibility in the contents of the video stream based on a plurality of factors associated with the video stream and/or at least one interest of a user. In an embodiment, the plurality of factors includes at least one of a pause state of the video stream, interaction of the user with the UE 302, interaction of the user with a linked device of the UE 302, interaction of the user with the target device 306, and lost contents from the video stream. In an embodiment, the interest/interaction of the user may be determined by various factors, for example, changed zoom ratio of the video, adjusted position of the video, and changed the focus from the video to some other part of the screen.

In an embodiment, the data visibility includes the at least one of the lost data or the data with the reduced visibility. Thus, the at least one of the lost data or the data with the reduced visibility may be determined and repositioning of the at least one of the lost data or the data with the reduced visibility is determined based on multiple parameters. Table 1 as provided below depicts an example of the determination whether data should be repositioned:

TABLE 1

| | Size of | | | Activity | | | | |
|---|---|---|---|---|---|---|---|---|
| | Playing | | | gone to | User | Multiple | Content | Should |
| Resolution | Content | Brightness | μ_{full} | onPause( ) | interaction | Displays? | Cut? | Reposition? |
| 480p | 25 × 36 | 36% | 0.12 | No | Yes | No | No | Yes |
| 144p | 147 × 249 | 84% | 0.19 | No | No | No | No | Yes |
| 1080p | 364 × 258 | 24% | 0.34 | No | No | No | No | No |
| 480p | 1080 × 11020 | 86% | 0.65 | Yes | No | Yes | No | Yes |
| 720p | 144 × 256 | 79% | 0.73 | Yes | No | Yes | No | Yes |
| 1080p | 1080 × 11020 | 100% | 1.00 | No | No | No | Yes | Yes |

In an embodiment, after determining the status of data visibility, the processor 404 may be configured to identify the data from the contents associated with the plurality of frames of the video stream. In an embodiment, the data includes the at least one of the lost data or the data with the reduced visibility, without departing from the scope of the disclosure. In an embodiment, the video stream may be displayed on the user equipment 302. In particular, the converting module 418 may be configured to convert the at least one frame from the plurality of frames into a plurality of grid blocks. In an embodiment, the at least one frame from the plurality of frames may be collected from the video stream and is provided to a grid mapper. The grid mapper creates a custom grid 602 for the at least one frame and forms a plurality of blocks on the at least one frame as shown in the FIG. 6. In an embodiment, the plurality of blocks may comprise a 256*256 grid of blocks, without departing from the scope of the disclosure. In another embodiment, the plurality of blocks may have different sizes and/or a different arrangement/number, without departing from the scope of the disclosure.

In an embodiment, the determining module 416 may be configured to determine a viewability index of each block of the at least one frame based on the plurality of parameters, to identify the data including the at least the lost data or the data with the reduced visibility. In an embodiment, the viewability index as determined for each block may be able to assist while calculating a threshold to determine whether each of the blocks is required to be repositioned. In an embodiment, a viewability index of the at least one frame from the contents may be stored in an array format having the viewability index for each block, where the viewability index of each block may be calculated by the Formula 1 as discussed earlier. Similarly, a viewability index of each block of each frame may be determined in an alternative manner which is not explained here for the sake of brevity. In an embodiment, the viewability index of each block may be stored in an array, which is denoted by:

$${A}_{μ} = \{ μ1 , μ2 , μ3 , μ4 … μ n \} \qquad [ Equation 1 ]$$

In an embodiment, after determining the viewability index of each block, the processor 404 may be configured to determine the plurality of regions 718, 720 in the plurality of frames. In particular, referring to FIG. 7A, the determining module 416 may be adapted to determine a first plurality of regions from the plurality of frames, at an initial state of the video stream as shown at a operation 702. At a operation 704, a second plurality of regions may be determined from the plurality of frames of the video stream after a specified time ‘t’. Further, the first plurality of regions and the second plurality of regions may be compared by the comparing module 420 to identify the plurality of regions 718, 720, where the plurality of regions may be a static region 718 and a dynamic region 720. In an embodiment, the static region 718 is the region in which there is no visible movement over the plurality of frames. The static region 718 may be two types, for example, ROI with textual data (the relevant data) and unwanted data (irrelevant data). The relevant data is explained as the meaningful and important data present in the static region. Further the irrelevant data is explained as the data provided in the static region which is not useful for the user. In an embodiment, the dynamic region 720 is explained where there is movement over the plurality of frames indicating the important visual data over which regenerated data cannot be placed as shown in FIG. 7B.

In an embodiment, from the determined plurality of regions 718, 720, a first region table is generated at a operation 708. Similarly, in an embodiment, the plurality of regions may be determined from the plurality of frames of the video stream multiple times, i.e., repeatedly after a specified X interval at a operation 710. Further, at a operation 712, a second region table is formed based on the determined X plurality of regions.

In an embodiment, at a operation 714, the comparing module 420 may be configured to compare the first region table and the second region table to generate a final plurality of regions 718, 720 from the plurality of frames at a operation 716. In an embodiment, the comparison of the plurality of regions 718, 720 corresponding to the plurality of frames may be performed after a specified time interval constantly to determine the plurality of regions 718, 720. In an embodiment, the plurality of frames may be analysed to identify if there is any textual data/pictorial representation present in the plurality of frames, which may comprise the relevant data. Once the data is identified, the region containing the data may be marked and stored in hashmaps, for example. Further, the marked data may be identified by moving periodically through the plurality of frames and further, the static region 718 or the dynamic region 720 may be identified subsequently.

For better understanding, the determination of the static region 718 may be explained with a non-limiting example. Referring to FIG. 7B, in one example, the colour composition of each block of at least one of the plurality of frames, after the specified time interval, may be determined by the determining module 416. Further, the colour composition of each block of another frame from the plurality of frames, at the initial state, may be determined by the determining module 416. Lastly, the colour composition of the resultant frame may be determined by computing the difference between the colour composition of the at least one of the plurality of frames and another frame from the plurality of frames to determine the static region 718 from the plurality of regions 718, 720 in the plurality of frames. The colour composition of each block may be determined by a formula as given below:

$$F = ( {\sum }_{i = 1}^{n} \text{?} ) / ( n * 255 ) \qquad [ Equation 2 ]$$

$$\text{?} \text{indicates text missing or illegible when filed}$$

In one example, the colour composition of each block may be calculated by considering RGB (γ′, I′, β) value of each block and considering the weighted average of each block.

In an embodiment, after determining the plurality of regions 718, 720, the determining module 416 may be configured to determine a viewability index of the plurality of regions 718, 720 as per a formula provided:

$${μ}_{g} = wi {\sum }_{i = 0}^{x} ( ( μ b ) ) / w \qquad [ Equation 3 ]$$

In an embodiment, x denotes the number of blocks in the region without departing from the scope of the disclosure. Further, examples of a dependency of the viewability index of each block and the plurality of regions is shown in a Table 2 below and FIG. 7B:

TABLE 2

| | Number of Blocks | | |
|---|---|---|---|
| Region | in Region | μb | μg |
| 1 | 24 | {0.12, 0.14 . . . 0.24} | 0.18 |
| 2 | 9 | {0.18, 0.19, 0.17 . . . 0.24} | 0.20 |
| 3 | 4 | {0.23, 0.21, 0.19, 0.20} | 0.21 |

In one embodiment, referring to FIG. 7B, after determining the plurality of regions 718, 720, the processor 404, more particularly, the identifying module 414 is configured to identify the plurality of regions 718, 720 from the plurality of frames of the video stream base on the identified contents.

In an embodiment, after identifying the plurality of regions 718, 720 from the plurality of frames, the processor 404, more particularly, the separating module 422 separates the relevant data and the irrelevant data from identified data, that is, the at least one of the lost data or the data with the reduced visibility included in at least one of the plurality of regions 718, 720. In one example, the separating module 422 may separate the relevant data and the irrelevant data from the at least one of the lost data or the data with the reduced visibility provided in either one of the static region 718 and the dynamic region 720, without departing from the scope of the disclosure.

In an embodiment, after the separation of the relevant data and the irrelevant data from the at least one of the lost data or the data with the reduced visibility provided in the at least one of the plurality of regions 718, 720, the processor 404, more particularly, the determining module 416 may be configured to determine the at least one of the plurality of regions 718, 720 having the identified data, that is, the at least one of the lost data or the data with the reduced visibility. In an embodiment, the at least one of the plurality of regions 718, 720 may be the static region 718 (as shown in FIG. 7B), without departing from the scope of the disclosure.

In an embodiment, the determining module 416 may be configured to determine a viewability index (average) of a plurality of blocks of the at least one of the plurality of regions 718, 720, that is, the static region 718. In an embodiment, the comparing module 420 may be configured to compare the determined viewability index with a threshold viewability index. In an embodiment, if after the comparison, the viewability index is less than the threshold viewability index the extracting module 424 extracts the relevant data from the identified data, that is, the at least one of the lost data or the data with the reduced visibility in the at least one of the plurality of regions, that is, the static region 718. In an embodiment, the determining module 416 may be configured to determine the viewability index of the relevant data based on the plurality of parameters associated with the video stream.

In particular, once the static region 718 is determined, a text identification engine/unit becomes active to identify the data including the at least one of the lost data or the data with the reduced visibility in the static region 718. In an embodiment, if the data including the at least one of the lost data or the data with the reduced visibility is identified, a technique is implemented to check whether the at least one of the lost data or the data with the reduced visibility as identified contains logo/important advertisement or divide the static region 718 with the text. In an embodiment, once the static region 718 is divided, the relevant data/text is extracted. In an embodiment, an input image file is provided where colour reduction and further ROI detection occur. Further, after detecting the ROI, a filtering unit is configured to filter the data. In an embodiment, the filtering unit may be configured to perform geometrical and morphological feature extraction, a neural network based classification and a connected component analysis.

In an embodiment, the filtered data is transmitted to a text extraction, recognition and storing unit. In an embodiment, the text extraction, recognition and storing unit may include a text region extraction and at least one optical character recognition. In an embodiment, the filtered data after transmitting from the text extraction, recognition and storing unit may provide the extracted relevant data.

In an embodiment, once the extracted relevant data is obtained, a semantic analysis is activated to break down the relevant data to identify meaningful words, differentiate between spacing, and change in colour composition.

Further, after the semantic analysis, the extracted relevant data may break down the static region 718 with similar groups with padding from stating text and an ending next. Thus, the relevant data is extracted and shown.

In an embodiment, once the relevant data is extracted, the processor 404, more particularly, the repositioning module 426 may be configured to reposition the relevant data in the at least one of the plurality of regions 718, 720, that is, the static region 718 based on the determined viewability index of the relevant data. The repositioned relevant data visible on the user interface 308 associated with the target device 306.

In an embodiment, referring to FIG. 8, for the repositioning of the relevant data in the at least one of the plurality of regions, the at least one processor 404, more particularly, the determining module 416 may be configured to analyze the extracted relevant data at a operation 802 and also determine screen area required for the relevant data at a operation 804.

At a operation 806, the determining module 416 may be configured to determine a size of the at least one of the plurality of regions 718, 720, that is, the static region 718. At a operation 808, the determining module 416 may determine whether the size of the static region 718 is optimum. In an embodiment, at a operation 814, the determining module 416 may be configured to determine a contrast ratio of the at least one of the plurality of regions, that is, the static region 718 and the relevant data, when the size of the at least one of the plurality of regions 718, 720 is optimum for the relevant data. In an embodiment, the contrast ratio may be 0.6 and 0.7, without departing from the scope of the disclosure.

At a operation 818, the determining module 416 may determine a viewability index of the at least one of the plurality of regions 718, 720, that is, the static region 718 and the relevant data. In an embodiment, the viewability index may be 0.87 and 0.89, without departing from the scope of the disclosure.

At a operation 820 and referring to A part of FIG. 9, the relevant data is repositioned in the at least one of the plurality of regions, that is, the static region 718, when the size of the static region 718 is optimum (e.g. large enough to fit/contain the relevant data). In an embodiment, a viewability index of the relevant data is determined to determine requirement of an overlay, after the repositioning of the relevant data, without departing from the scope of the disclosure. Further, the repositioned relevant data is visible on the user interface 308 associated with the target device 306 and should not obstruct any part, e.g. a play/pause option, of the user interface.

Further, in an embodiment, at a operation 810, when the size of the at least one of the plurality of regions 718, 720, that is, the static region 718 is not optimum for the relevant data, the processor 404 is configured to form the overlay as shown in B part of FIG. 9.

In an embodiment, for forming the overlay, referring to FIG. 10, at a operation 1002, the processor 404, more particularly, the extracting module 424 may be configured to extract a colour matrix of the at least one of the plurality of regions 718, 720, that is, the static region 718. In an embodiment, the processor 404 is configured to provide the extracted colour matrix in a colour synthesizer at a operation 1004. In an embodiment, in the colour synthesizer, the processor 404 may be configured to select a color spectrum with a contrasting colour at a operation 1006. Further, the determining module 416 may be configured to determine a colour coefficient of each colour provided in the colour spectrum at a operation 1008.

In an embodiment, the processor 404 may be configured to prepare a candidate list of contrasting colours at a operation 1010.

In an embodiment, the determining module 416 may be configured to determine a contrast coefficient of each of the colour (candidate colour) with the colour matrix of the static region 718 to select an optimum colour at operations 1012 and 1014. In an embodiment, the determining module 416 may be configured to determine a viewability index to generate an optimum shape having the optimum colour at a operation 1016. In an embodiment, the viewability index may be calculated by a Formula as shown below:

$$μ = \frac{{\sum }_{i = 1}^{5} {σ}_{i} \times {∈}_{i}}{σ \times {∈}_{max}} \qquad [ Equation 4 ]$$

Further, the relationship between the values of the Formula 4 is provided below:

TABLE 3

| | |
|---|---|
| ${∈}_{1} = \frac{Resolution}{Device ( sw ) DPI}$ | Resultant resolution must be same as of device resolution |
| ${∈}_{2} = \frac{Overlay Size}{Total Static Region} * 100$ | Only 20% of static region should be covered |
| ${∈}_{3} = \frac{Contrast}{75}$ | Contrast must optimum (75%) |
| ${∈}_{4} = \frac{Brightness}{Device Brightness}$ | Brightness should be comparable to device brightness |
| ${∈}_{5} = \frac{Text Size}{Font Size}$ | Resultant Text Size should be comparable to Font Size |

In an embodiment, the processor 404 may be configured to apply the optimum colour and the optimum shape to the overlay, when the viewability index is optimum at a operation 1020. In an embodiment, an optimum range of the viewability index may be 0.85>μ<0.95. In an embodiment, when the optimum viewability index is not achieved at a operation 1018 the determining module 416 again determines the contrast coefficient of each of the colour with the colour matrix of the static region 718 to select the optimum colour and so on the process continues till the optimum viewability index is achieved.

In an embodiment, after applying the optimum colour and the optimum shape to the overlay at a operation 1022, the processor 404 may be configured to further select background of the overlay. In an embodiment, as shown in FIG. 11, the background is selected based on a combination of a colour 1102 of the static region 718, a background colour 1104 corresponding to the relevant data in the static region 718, and a foreground colour 1106 corresponding to the relevant data in the static region 718; and selecting font 1108 of the plurality of parts of the relevant data. In an embodiment, the background may be provided in two ways, for example, using same background as used in the extracted shape of the overlay. This may be used/implemented when a similar background does not hamper visibility of area where the overlay may be placed. Further, different background may be implemented that adjust with a background of an area where the overlay may be placed. In an embodiment, while placing the overlay, if original background hampers viewability, the background of the overlay changes in accordance with the background of the overlay area.

In an embodiment, once the background is implemented in the overlay and optimum colour is implemented in the overlay, the processor 404 may place the overlay on the user interface 308 of the target device 306.

In an embodiment, the overlay may be placed on such area from where user viewing comfort is maintained. Further, the processor 404 is configured to identify the shape of the overlay. In an embodiment, the shape/position of the overlay may be selected on various parameters, for example, colour of entire screen and an area where same colour is present on the user interface 308 may be used as that depict the static region having the relevant data. Further, the overlay may be placed on the user interface 308 such that all necessary contents of the video stream may be visible. Further, the position of the overlay may vary on the static region 718, without departing from the scope of the disclosure. Further, the overlay may not be placed on the user interface 308 where the user interaction is possible or may overlap with logo/important advertisement. In one example, the user interaction may be a play/pause option, forward/rewind option and any other controls, without departing from the scope of the disclosure. Lastly, the positioning of the overlay may be denoted by:

$$1. {\sum }_{i = 1}^{n} Overlay Location ⋂ Video Controls Location = ∅ \qquad [ Equation 5 ]$$

In an embodiment, the shape of the overlay may be rectangular, oval, square or any other shape while maintaining video streaming experience of the user, without departing from the scope of the disclosure.

In an embodiment, the processor 404 may be configured to divide the relevant data into a plurality of parts to be placed within the identified shape of the overlay. In one example, the determination of the shape of the overlay may be determined in real time. In one example, textual blocks of the relevant data are divided into smaller blocks and further, the static region 718 is determined in which each block has to be placed. If the blocks are unable to be placed in the static region 718, each block is further split till a threshold value. Further, once the threshold value is reached and the blocks are still unable to fit in the static region 718, in that case, the relevant data may be divided into the plurality of parts, where the plurality of parts may be placed in the overlay as shown in FIG. 9.

In an embodiment, the repositioning module 428 may be configured to reposition the relevant data in the at least one of the plurality of regions, that is, the static region 718. The repositioned relevant data is visible on the user interface 308 associated with the target device 306.

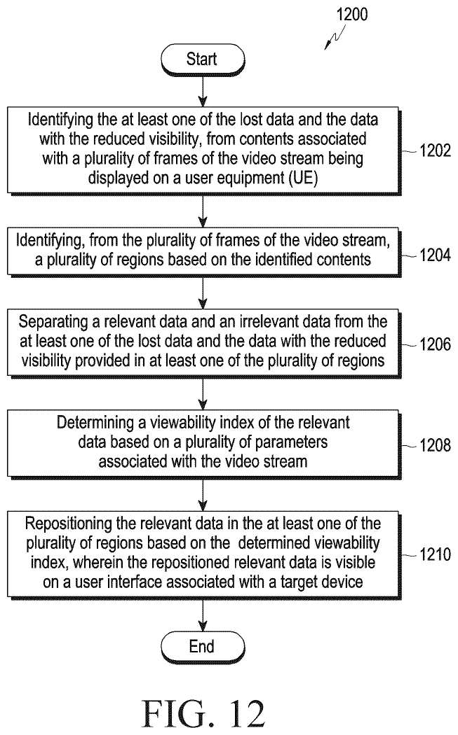

FIG. 12 illustrates a method 1200 performed by the system 304, in accordance with an embodiment of the disclosure.

The method 1200 may be performed by programmed computing devices, for example, based on instructions retrieved from non-transitory computer readable media. The computer readable media may include machine-executable or computer-executable instructions to perform all or portions of the described method. The computer readable media may be, for example, digital memories, magnetic storage media, such as magnetic disks and magnetic tapes, hard drives, or optically readable data storage media.

The method 1200 includes a series of operations shown at operation 1202 through operation 1210 of FIG. 12. The method 1200 may be performed by the system 304 in conjunction with the modules 412, the details of which are explained in conjunction with FIGS. 3 to 10 and the same are not repeated here for the sake of brevity in the disclosure. The method 1200 begins at operation 1202.

At a operation 1202, the method 1200 includes identifying the data from the plurality of frames of the video stream being played on the UE 302. The data includes the at least one of the lost data or the data with the reduced visibility. The method 1200 includes converting the at least one frame from the plurality of frames into a plurality of grid blocks. Further, the method 1200 includes determining the viewability index of each block of the at least one frame based on the plurality of parameters, to identify the data including the at least one of the lost data or the data with the reduced visibility.

Further, prior to the identification of the data from the contents associated with the plurality of frames, the method 1200 includes identifying at least one mode from a plurality of modes of the video stream. In an embodiment, the plurality of modes includes one of the display mode and the hidden mode. Furthermore, the method 1200 includes determining the viewability index of the at least one frame from the plurality of frames based on the plurality of parameters. The plurality of parameters includes the at least one of the resolution, the content size, the brightness, the distance, and the orientation. The method 1200 includes determining the status of the data visibility in the contents of the video stream based on the status of the plurality of factors associated with the video stream and the at least interest of the user. In an embodiment, the plurality of factors includes the at least one of the pause state of the video stream, the interaction of the user with the UE 302, the interaction of the user with the linked device of the UE 302, the interaction of the user with the target device 306, and lost contents from the video stream. In an embodiment, the status of the data visibility includes the at least one of the lost data or the data with the reduced visibility.

At a operation 1204, the method 1200 includes identifying, from the plurality of frames of the video stream, the plurality of regions 718, 720 based on the identified contents. In an embodiment, prior to the identification, from the plurality of frames of the video stream, of the plurality of regions, for determining the plurality of regions 718, 720, the method 1200 includes determining the first plurality of regions from the plurality of frames, at an initial state of the video stream (as shown in the operation 702 of FIG. 7a). The method 1200 includes determining the second plurality of regions from the plurality of frames of the video stream after the specified time interval (as shown in the operation 704 of FIG. 7a). The method 1200 includes comparing the first plurality of regions and the second plurality of regions to determine the plurality of regions. In an embodiment, the plurality of regions includes the static region 718 (as shown in FIG. 7b) and a dynamic region 720 (as shown in FIG. 7b). Further, the method 1200 includes determining the viewability index of the determined plurality of regions.

At a operation 1206, the method 1200 includes separating a relevant data and an irrelevant data from the identified data provided in the at least one of the plurality of regions 718, 720. After the separation of the relevant data and the irrelevant data from the identified data, provided in the at least one of the plurality of regions 718, 720, the method 1200 includes determining the at least one of the plurality of regions 718, 720 having the identified data. In an embodiment, the at least one of the plurality of regions 718, 720 is the static region 718. The method 1200 includes determining the viewability index of the plurality of blocks of the at least one of the plurality of regions 718, 720. The method 1200 includes comparing the determined viewability index with a threshold viewability index. The method 1200 includes extracting, based on the comparison (e.g. if the determined viewability index is less than the threshold viewability index), the relevant data from the at least one of the lost data or the data with the reduced visibility in the at least one of the plurality of regions 718, 720.

At a operation 1208, the method 1200 includes determining the viewability index of the relevant data based on the plurality of parameters associated with the video stream.

At a operation 1210, the method 1200 includes repositioning the relevant data in the at least one of the plurality of regions 718, 720 based on the determined viewability index. For example, the relevant data may be repositioned in a static region if the determined viewability index of the result is acceptable, e.g. greater than a threshold value, which may be related to the viewability index determined for the full frame. In an embodiment, the repositioned relevant data is visible on the user interface 308 associated with the target device 306.

For the repositioning the relevant data in the at least one of the plurality of regions 718, 720, the method 1200 includes determining the size of the at least one of the plurality of regions 718, 720, where the at least one of the plurality of regions 718, 720 is the static region 718. The method 1200 includes determining the contrast ratio of the at least one of the plurality of regions 718, 720 and the relevant data, when the size of the at least one of the plurality of regions 718, 720 is optimum for the relevant data. The method 1200 includes determining the viewability index of the at least one of the plurality of regions 718, 720 and the relevant data. The method 1200 includes repositioning the relevant data in the at least one of the plurality of regions 718, 720 wherein the repositioned relevant data is visible on the user interface 308 associated with the target device 306.

In an embodiment, when the size of the at least one of the plurality of regions 718, 720 is not optimum for the relevant data, the method 1200 includes forming the overlay. For the formation of the overlay, the method 1200 includes extracting the colour matrix of the at least one of the plurality of regions, where the at least one of the plurality of regions 718, 720 is the static region 718. The method 1200 includes selecting the colour spectrum with the contrasting colour. The method 1200 includes determining the colour coefficient of each colour provided in the colour spectrum. The method 1200 includes determining the contrast coefficient of each of the colour with the colour matrix of the static region to select the optimum colour. The method 1200 includes determining the viewability index to generate the optimum shape having the optimum colour. The method 1200 includes applying the optimum colour and the optimum shape to the overlay, when the viewability index is optimum.

Further, the method 1200 includes selecting background of the overlay, where the background is selected based on the combination of the static region 718, the background colour corresponding to the relevant data in the static region 718, and the foreground colour corresponding to the relevant data in the static region 718. The method 1200 includes selecting the font of the plurality of parts of the relevant data.

After determining the background of the overlay, the method 1200 includes placing the overlay on the user interface 308 of the target device 306.

The method 1200 includes identifying the shape of the overlay. Further, the method 1200 includes dividing the relevant data into the plurality of parts to be placed within the identified shape of the overlay. Lastly, the method 1200 includes repositioning of the relevant data in the at least one of the plurality of regions 718, 720 where the repositioned relevant data is visible on the user interface 308 associated with the target device 306. In an embodiment, the overlay is configured to place the plurality of parts of the relevant data on the user interface 308 of the target device 306.

In an embodiment, the relevant data is repositioned on the user interface 308 of the target device 306, in response to receiving a user input indicative of switching from the video stream which is explained in details with reference to FIGS. 12A-12C.

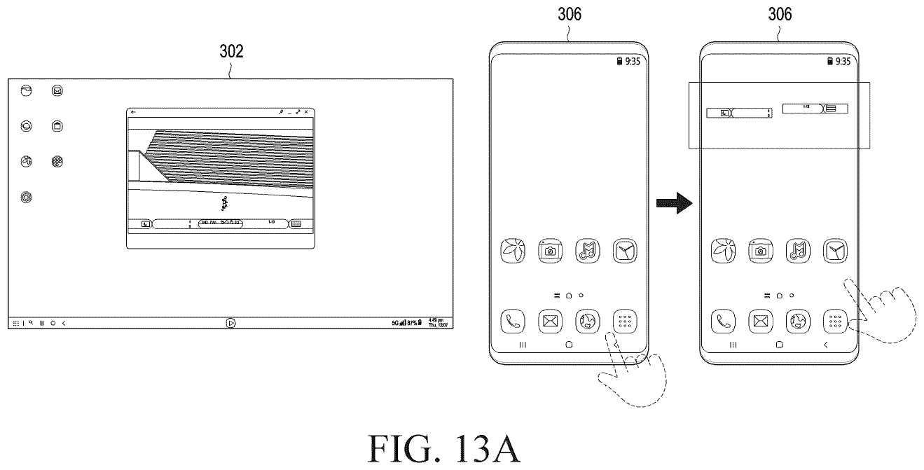

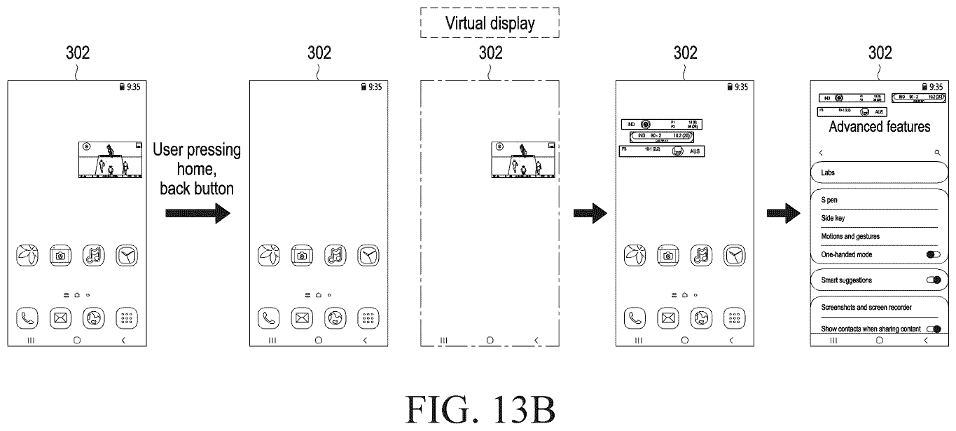

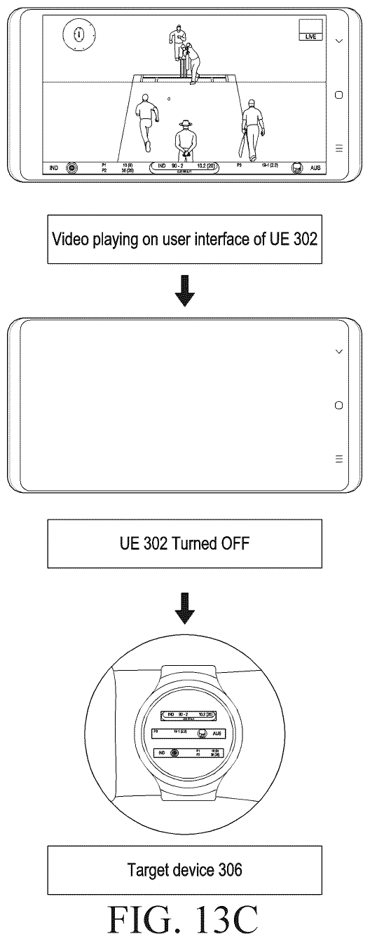

FIGS. 13A, 13B, and 13C illustrate multiple use cases of the system 304 for repositioning the at least one of the lost data or the data with reduced visibility, in accordance with an embodiment of the disclosure.

Referring to FIG. 13A, in one example, the video streaming is happening on the UE 302, that is, a television and the user is actively using the target device 306, that is, the smartphone. The smartphone and the television are connected with each other through an application, for example, intmDisplay. This application provides a total number of displays connected with the UE 302 and also, a display on which the user is currently working with help of touches detected on the display and other user patterns. Therefore, in the use case, since the user is busy on the smartphone and the video streaming is happening on the TVthe relevant data may be visible on the smartphone.

Referring to FIG. 13B, when the user is streaming the video in PIP mode and from the video stream (as shown in FIGS. 13B (1) and 13b (2)) by pressing home button, exit button, in that case, a plurality of frames/raw images may be obtained and a virtual display (as shown in FIG. 13B (3)) with a new display ID is created by the processor 404. Further, a new surface is created for presenting the frames of the video stream. The properties from a Surface View of the contents/the relevant data is extracted and shown on the user interface 308 of the target device 306. Lastly, the relevant data may be repositioned according to a context of the user interface 308 of the target device 306 and the user interaction (as shown in FIG. 13B(4) and FIG. 13N(5)). In this case, the UE 302 and the target device 306 are same, without departing from the scope of the disclosure.

Referring to FIG. 13C, the UE 302 and the target device 306 may be connected to each other. In one example, the UE 302 may be the smartphone and the target device 306 may be the smart watch. Further, the video stream may happen on the smartphone and the smartphone may become inactive due to multiple factors, for example, switch off, the user exiting from the video, etc. In that case, the relevant data may be visible on the smartwatch as worn by the user.

As will be gathered, the system 304 and the method 1200 as disclosed may provide a comprehensive approach to identifying and repositioning the at least one of the lost data or the data with the reduced visibility in the user interface 308 of the target device 306. The present configuration provides repositioning of the relevant data from the at least one of the lost data or the data with the reduced visibility in a manner that the user accessibility and viewability are not hampered. Further, the system 304 and the method 1200 provides repositioning of the relevant data in a multi display scenario, in a multi device connection scenario and in a scenario when the user exits from the video stream, thus providing flexibility for the user to perform multitasking while accessing the relevant data from the video stream.

While specific language has been used to describe the disclosure, any limitations arising on account thereto, are not intended. As would be apparent to a person in the art, various working modifications may be made to the method 1200 in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method of repositioning data associated with a video stream, the method \ comprising:
identifying data from a plurality of frames of the video stream being played on a user equipment (UE);
identifying a plurality of regions from the plurality of frames of the video stream;
separating first data and second data from the identified data in at least one of the plurality of regions;
determining a viewability index of the first data based on a plurality of parameters of the video stream; and
repositioning the first data in the at least one of the plurality of regions based on the determined viewability index, wherein the repositioned first data is visible on a user interface associated with a target device.

2. The method as claimed in claim 1, wherein prior to the identification of the data, the method comprises:
identifying at least one mode from a plurality of modes of the video stream, wherein the plurality of modes includes a display mode and a hidden mode.

3. The method of claim 2, wherein the method comprises:
determining data visibility of contents of the video stream based on a plurality of factors associated with the video stream,
wherein the plurality of factors includes at least one of a pause state of the video stream, interaction of the user with the UE, interaction of the user with a linked device of the UE, interaction of the user with the target device, and lost contents from the video stream.

4. The method of claim 1, wherein the identification of the data comprises:
converting at least one frame from the plurality of frames into a plurality of blocks; and
determining a viewability index of each block of the plurality of blocks based on the plurality of parameters, to identify the data, wherein the plurality of parameters includes at least two of a resolution, a content size, a brightness, a distance, and an orientation.

5. The method of claim 1, wherein prior to the identification the plurality of regions, the method comprises:
determining a first plurality of regions from the plurality of frames at an initial state of the video stream;
determining a second plurality of regions from the plurality of frames after a specified time interval;
comparing the first plurality of regions and the second plurality of regions to determine whether the plurality of regions includes a static region or a dynamic region; and
determining a viewability index of the determined static region.

6. The method of claim 1, wherein after the separation of the first data and the second data from the identified data in the at least one of the plurality of regions, the method comprises:
determining the at least one of the plurality of regions having the identified data, wherein the at least one of the plurality of regions is a static region;
determining a viewability index of a plurality of blocks of the at least one of the plurality of regions;
comparing the determined viewability index with a threshold viewability index; and
in response that the determined viewability index is less than the threshold viewability index, extracting the first data from the identified data in the at least one of the plurality of regions.

7. The method of claim 1, wherein the repositioning the first data in the at least one of the plurality of regions comprises:
determining a size of the at least one of the plurality of regions, where the at least one of the plurality of regions is a static region;
determining a contrast ratio of the at least one of the plurality of regions and the first data, in case that the size of the static region is optimum for the first data;
determining a viewability index of the static region; and
repositioning the first data in the static region based on the determined viewability index of the static region, wherein the repositioned first data is visible on the user interface associated with the target device.

8. The method of claim 7, wherein in case that the size of the static region is not optimum for the first data, the method comprises:
forming an overlay;
identifying a shape of the overlay;
dividing the first data into a plurality of parts to be placed within the identified shape of the overlay; and
placing the overlay on the user interface of the target device, wherein the overlay is configured to place the plurality of parts of the first data on the user interface of the target device.

9. The method of claim 8, wherein before placing the overlay on the user interface of the target device, the method comprises:
selecting background of the overlay, wherein the background is selected based on a combination of the static region, a background colour corresponding to the first data in the static region, and a foreground colour corresponding to the first data in the static region; and
selecting a font of the plurality of parts of the first data.

10. The method of claim 1, wherein the first data is repositioned on the user interface of the target device in response to receiving a user input indicative of switching from the video stream.

11. A system configured to reposition data associated with a video stream, the system comprising:
at least one processor including processing circuitry; and
memory storing instructions that, when executed by the at least one processor individually or collectively, cause the system to:
identify data from a plurality of frames of the video stream being played on a user equipment (UE);
identify a plurality of regions from the plurality of frames of the video stream;
separate first data and second data from the identified data in at least one of the plurality of regions;
determine a viewability index of the first data based on a plurality of parameters of the video stream; and
reposition the first data in the at least one of the plurality of regions based on the determined viewability index, wherein the repositioned first data is visible on a user interface associated with a target device.

12. The system of claim 11, wherein the target device comprises the UE or a different device wirelessly connected to the UE.

13. The system of claim 12, wherein the target device is at least one of smart watch, a television, a desktop, a laptop, or a smartphone.

14. The system of claim 11, wherein prior to the identification of the data, the instructions, when executed by the at least one processor individually or collectively, further cause the system to:
identify at least one mode from a plurality of modes of the video stream, wherein the plurality of modes includes a display mode and a hidden mode.

15. One or more non-transitory computer-readable storage media storing one or more computer programs including computer-executable instructions that, when executed by at least one processor, cause a user equipment to perform operations, the operations comprising:
identifying data from a plurality of frames of the video stream being played on a user equipment, UE;
identifying a plurality of regions from the plurality of frames of the video stream;
separating first data and second data from the identified data in at least one of the plurality of regions;
determining a viewability index of the first data based on a plurality of parameters of the video stream; and
repositioning the first data in the at least one of the plurality of regions based on the determined viewability index, wherein the repositioned first data is visible on a user interface associated with a target device.
